(19) United States
(12) Patent Application Publication
(10) Pub. No.: US 2014/0375542 A1
(43) Pub. Date: Dec. 25, 2014

(54) ADJUSTING A NEAR-EYE DISPLAY DEVICE

(71) Applicants: Steve Robbins, Bellevue, WA (US); Scott C. McEldowney, Redmond, WA (US); Xinye Lou, Redmond, WA (US); David D. Bohn, Fort Collins, CO (US); Quentin Simon Charles Miller, Sammamish, WA (US); John Robert Eldridge, Bellevue, WA (US); William M. Crow, Sequim, WA (US)

(72) Inventors: Steve Robbins, Bellevue, WA (US); Scott C. McEldowney, Redmond, WA (US); Xinye Lou, Redmond, WA (US); David D. Bohn, Fort Collins, CO (US); Quentin Simon Charles Miller, Sammamish, WA (US); John Robert Eldridge, Bellevue, WA (US); William M. Crow, Sequim, WA (US)

(21) Appl. No.: 13/926,322

(22) Filed: Jun. 25, 2013

(51) Int. Cl. G02B 27/01; G06T 19/00; G06F 3/01

(52) U.S. Cl. CPC G02B 27/0179; G06F 3/013; G06T 19/006
USPC 345/156

(57) ABSTRACT

Embodiments are disclosed herein that relate to aligning a near-eye display of a near-eye display device with an eye of a user. For example, one disclosed embodiment provides, on a near-eye display device, a method comprising receiving an image of an eye from a camera via a reverse display optical path, detecting a location of the eye in the image, and determining a relative position of the eye with regard to a target viewing position of the near-eye display. The method further comprises determining an adjustment to make to the near-eye display device to align the location of the eye with the target viewing position.

### BACKGROUND

Near-eye display devices are configured to present images to a user via a display that is positioned close to the user's eyes. For example, a head-mounted augmented reality display device may be worn on a user's head to position a near-eye display directly in front of a user's eyes. A near-eye display may be at least partially see-through to allow a user to view a real-world background in combination with displayed virtual objects. This may allow virtual objects to be displayed such that the virtual objects appear to exist within the real-world environment.

### SUMMARY

Embodiments are disclosed herein that relate to aligning a near-eye display with an eye of a user. For example, one disclosed embodiment provides, on a near-eye display device, a method comprising receiving an image of an eye from a camera via a reverse display optical path, detecting a location of the eye in the image, and determining a relative position of the eye to a target viewing position of the near-eye display. The method further comprises determining an adjustment to make to align the location of the eye with the target viewing position.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an example near-eye worn by a user.

FIG. 2 shows an example of an output of a recommended adjustment to align a user's eye with a target viewing position of a near-eye display.

FIG. 3 shows an example head-mounted display comprising a horizontal adjustment mechanism, a vertical adjustment mechanism, and a speaker.

FIG. 4 shows a flow diagram depicting an example method for aligning a near-eye display with an eye of a user.

FIGS. 5A and 5B show an example optics configuration usable to acquire images of an eye to locate the eye relative to a target viewing position.

FIGS. 6A-6D show other examples of recommended adjustments to align the location of the eye with the target viewing position of a near-eye display.

FIG. 7 shows an example embodiment of a computing system.

### DETAILED DESCRIPTION

A near-eye display device may use various optical systems to deliver an image to a user's eye, including but not limited to projection-based systems and waveguide-based systems. However, the optical systems of such near-eye displays may have relatively small exit pupils. Further, in some near-eye displays, optical performance may decay toward the edge of the exit pupil.

As such, a near-eye display device may include an adjustable fit system to allow a user to properly locate the exit pupil of the system. This may allow a user to adjust the system to avoid optical effects caused by misalignment. However, the proper adjustment of such a fit system may pose challenges for users. As a result, some users may perform sufficient fit adjustments to find a coarse fit that provides an acceptable level of performance, and then not perform additional adjustment to further optimize viewing. Thus, such viewers may not enjoy the full viewing experience offered by the device.

Accordingly, embodiments are disclosed herein that relate to assisting users in adjusting a near-eye display device. Briefly, the disclosed embodiments determine from image data a relative position between the location of an eye of a user and a target viewing position of the near-eye display, and determine an adjustment to make to the near-eye display device that aligns the eye with the target viewing position. The determined adjustment may be performed automatically and/or output as a recommendation for the user to perform manually. This may help to simplify adjusting the near-eye display system to more precisely align the near-eye display system with the user's eye or eyes. It will be understood that reference herein to a location of an eye may signify a location of the overall eye structure, the pupil of the eye, and/or any other anatomical feature of the eye.

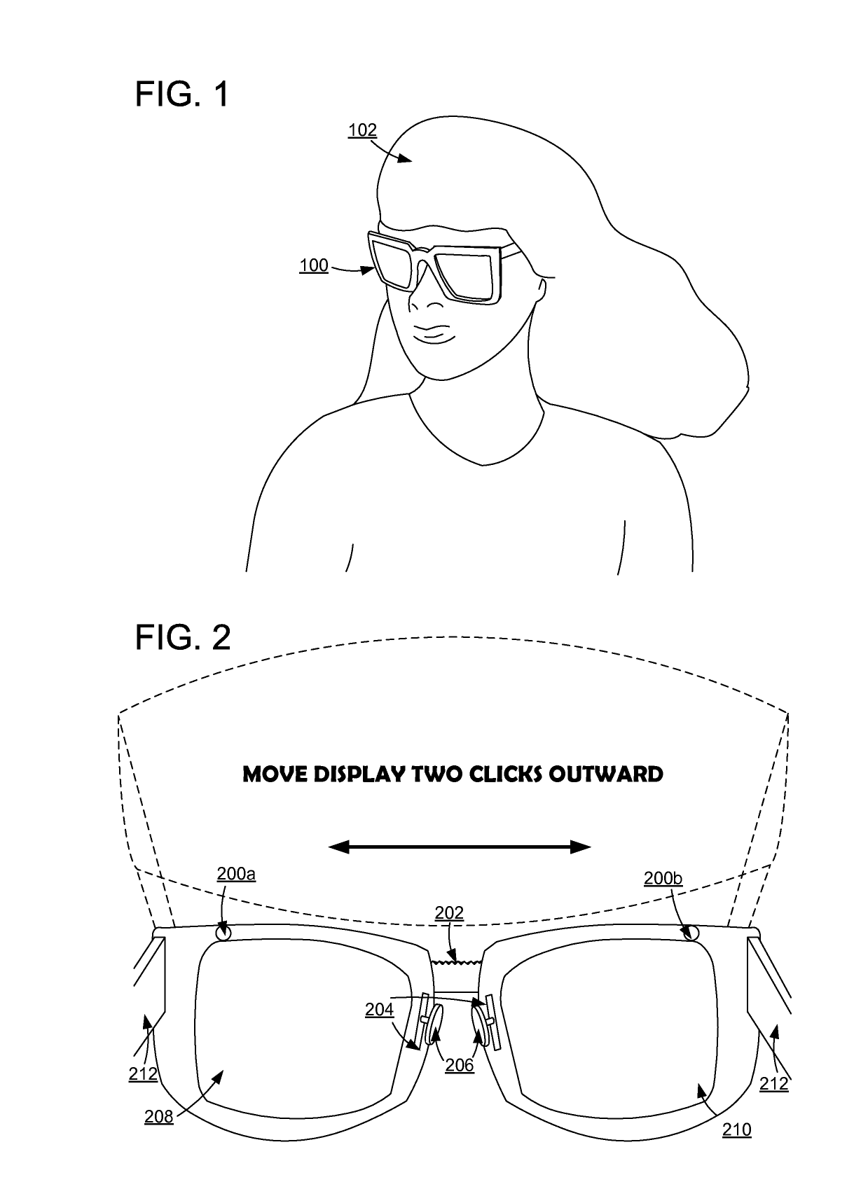

FIG. 1 shows an example embodiment of a near-eye display system in the form of a head-mounted display device 100 worn by a user 102. Head-mounted display device 100 may be used, for example, to display augmented reality images via a see-through display in which displayed virtual objects are viewable along with physical objects in a real-world background scene. While described in the context of a head-mounted display device, it will be understood that the disclosed embodiments may be used with any other suitable near-eye display device.

As discussed above, misalignment of the display optics of the head-mounted display device with the user's eye may result in vignetting of the field of view and other optical effects. Thus, for proper viewing, a fit system and/or other mechanisms may be used to place the head-mounted display at a target viewing position relative to the user's eyes. The target viewing position may be defined, for example, by a region in space inside of which an eye may properly perceive displayed images.

Achieving a proper fit via a fit system may pose challenges. For example, some near-eye displays may be fit to a user via professional equipment that is used to determine anatomical measurements related to the eye. However, such methods may be too expensive and cumbersome for use with consumer devices.

Thus, as mentioned above, to facilitate proper alignment between the target viewing position and a user's eye, a near-eye display may be configured to detect a location of a user's eye from image data, and output a recommendation regarding an adjustment to make to the near-eye display to place the user's eye in a target viewing position relative to the near-eye display.

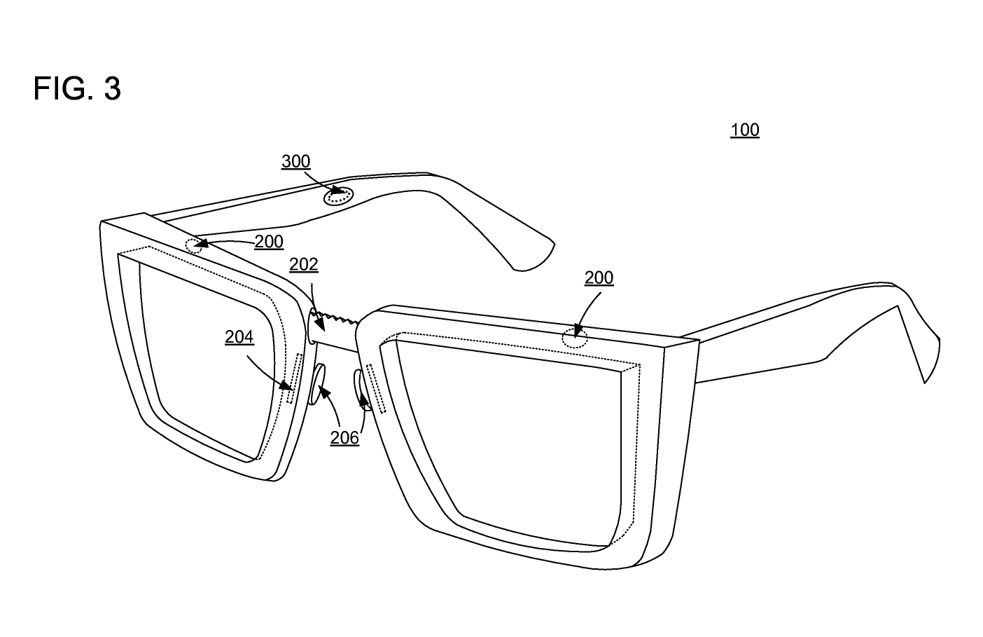

FIG. 2 shows a schematic depiction of a view of a user of head-mounted display device 100. The depicted head-mounted display device 100 includes a left eye camera 200a and a right eye camera 200b, and a horizontal adjustment mechanism schematically depicted at 202, wherein the cameras have a known spatial relationship to the target viewing position. The cameras 200a, 200b may be configured to capture images of each of a user's eyes for detecting a location of each of the user's eyes. From such image data, a difference between a detected eye location and a target viewing position may be determined If a target viewing position is not currently aligned with the eye, the head-mounted display system may determine an adjustment that may be made to align the target viewing position with the eye. The adjustment may then be performed automatically, or recommended to a user. As one non-limiting example of a recommendation, FIG. 2 shows text displayed on a near-eye display that instructs a user to “move the display two clicks outward.” Further, the cameras 200a, 200b may be controlled to capture images periodically to allow the location of the user's eyes relative to the target viewing positions to be tracked, and update the displayed instruction accordingly until proper fit has been achieved.

The head-mounted display device 100 may determine an adjustment to perform or recommend in any suitable manner For example, the head-mounted display system may determine an offset of the user's eye (or pupil or other anatomical feature of the user's eye) from the target viewing position for that eye, and may output a recommendation based upon a known or determined relationship between operation of an adjustment mechanism and a change in the location of the user's eye relative to the target viewing position as a function of the operation of the adjustment mechanism.

Any suitable adjustment may be recommended and/or performed. For example, some devices may offer multiple adjustment mechanisms (horizontal, vertical, angular, etc.). In such devices, multiple recommendations may be output, or multiple adjustments performed, in some situations, depending upon the adjustments to be made. Where multiple adjustments are recommended, the recommendations may be output together as a list, may be sequentially displayed (e.g. such that the system first displays a subset of one or more recommended adjustments, and then waits for the user to make those recommended adjustments before displaying one or more other recommended adjustments), or may be output in any other suitable manner

Other devices may offer fewer adjustment mechanisms (e.g. an interpupillary distance adjustment but no vertical adjustment). Further, some devices, such as wearable devices (e.g. head-mounted display systems), may be offered in multiple sizes. In such embodiments, the recommendation may suggest a different sized device, as described in more detail below.

The depicted horizontal adjustment mechanism 202 allows the distance between a left eye display 208 and a right eye display 210 to be adjusted, for example, based upon an interpupillary distance of a user to position the left eye in a left eye target viewing position and the right eye in a right eye target viewing position. In some embodiments, other horizontal adjustment mechanisms may be provided. For example, a horizontal adjustment mechanism (not shown) may be provided that adjusts a distance between each earpiece 212 and associated left or right eye display. Such adjustment mechanisms may be configured to adjust the positions of the left eye display 208 and the right eye display 210 in a complementary or independent manner.

In addition to the horizontal adjustment mechanism 202, FIG. 2 also shows a schematic depiction of a vertical adjustment mechanism 204 that allows a user to raise or lower the left eye display 208 and right eye display 210 relative to a user's eye by raising or lowering a nose bridge 206. The horizontal adjustment mechanism 202 and the vertical adjustment mechanism 204 each may be manually adjustable, or may be adjusted via powered mechanical mechanisms (e.g. stepper motors). Where powered mechanical mechanisms are provided, the mechanisms may be user-controlled and/or may be system-controlled to perform adjustments automatically. It will be understood that the adjustment mechanisms schematically depicted in FIG. 2 are presented for the purpose of example, and that any other suitable adjustment mechanisms may be utilized. For example, other adjustment mechanism may allow for adjustments in the distance of the display(s) from the user's eyes, and/or rotational adjustments about various axes. It will be understood that, in some embodiments, each eye may have independent vertical and/or horizontal adjustment mechanisms to allow the display for each eye to be independently aligned with the corresponding eye.

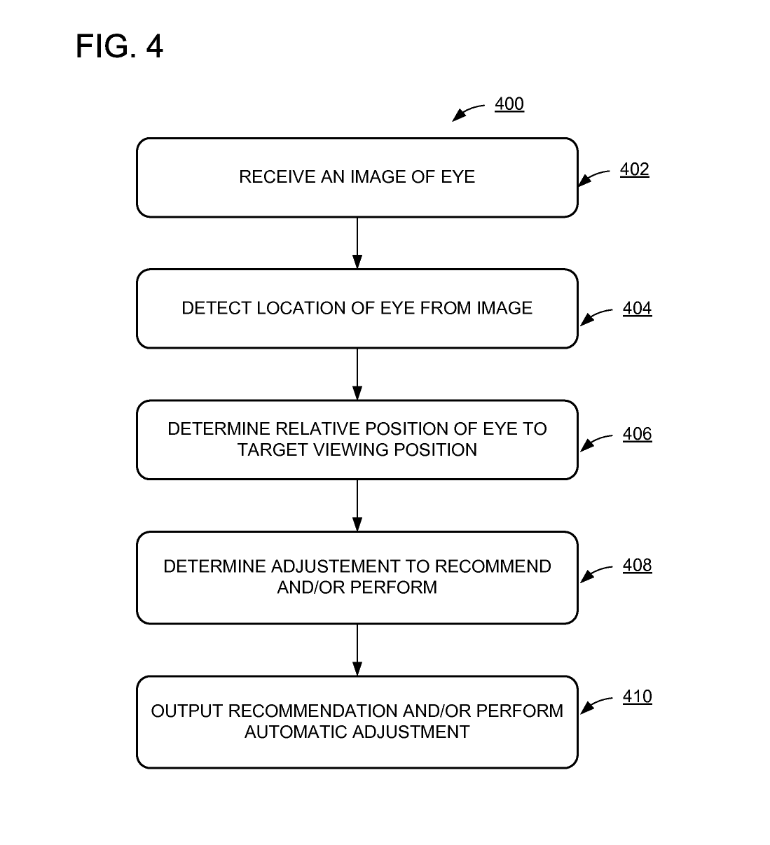

FIG. 2 shows the head-mounted display device 100 as outputting a visual adjustment recommendation. However, any other suitable type of recommendation may be output. For example, in some embodiments, a recommendation may be output acoustically. FIG. 3 shows another view of head-mounted display device 100, and schematically illustrates speakers 300 that may be used to output acoustic recommendations to a user. Such acoustic recommendations may take any suitable form, including but not limited to a computer-generated voice output providing a recommendation in an appropriate language (e.g. as selected by a user), by tones or other sounds that are not specific to any language and that indicate a direction (e.g. by pitch) and magnitude (e.g. by number of tones, volume, etc.) of an adjustment to make, and/or in any other suitable manner. Further, in some embodiments, the recommendation may comprise a combination of visual and acoustic outputs. In yet other embodiments, other types of outputs may be used, such as haptic/tactile outputs (e.g. outputting vibration from a location that indicates a direction to make an adjustment and/or at an intensity that indicates a magnitude of a correction to be made).

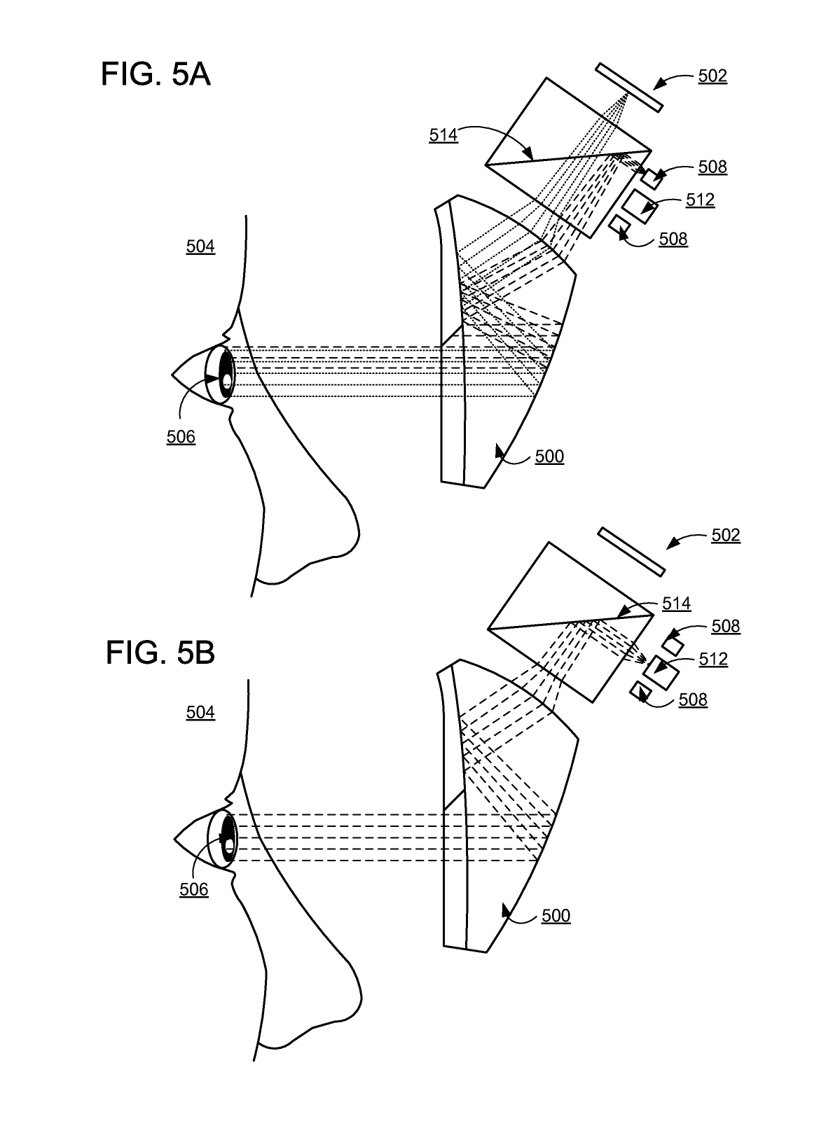

FIG. 4 shows an example embodiment of a method 400 for aligning a user's eye with the target viewing position of a near-eye display. Method 400 may be performed on any suitable near-eye display device, including but not limited to a head-mounted display device. Method 400 comprises, at 402, receiving an image of an eye. Any suitable optical arrangement may be used to capture the image of the eye. For example, in some embodiments, the image may be captured using a camera having a direct view of the user's eye, as shown in FIGS. 2 and 3. In some embodiments, method 400 may comprise receiving images of a first eye (e.g. a left eye) and a second eye (e.g. a right eye) from first and second cameras respectively having direct views of the first and second eyes.

In other embodiments, various optical components may be used to deliver an image of the user's eye to a camera not positioned to directly image the user's eye. For example, in a head-mounted display device, various optical components may be used to deliver display images to a user's eye. These components may be referred to herein as a display optical path. In such a device, a reverse display optical path may be used to deliver images of the eye to the camera.

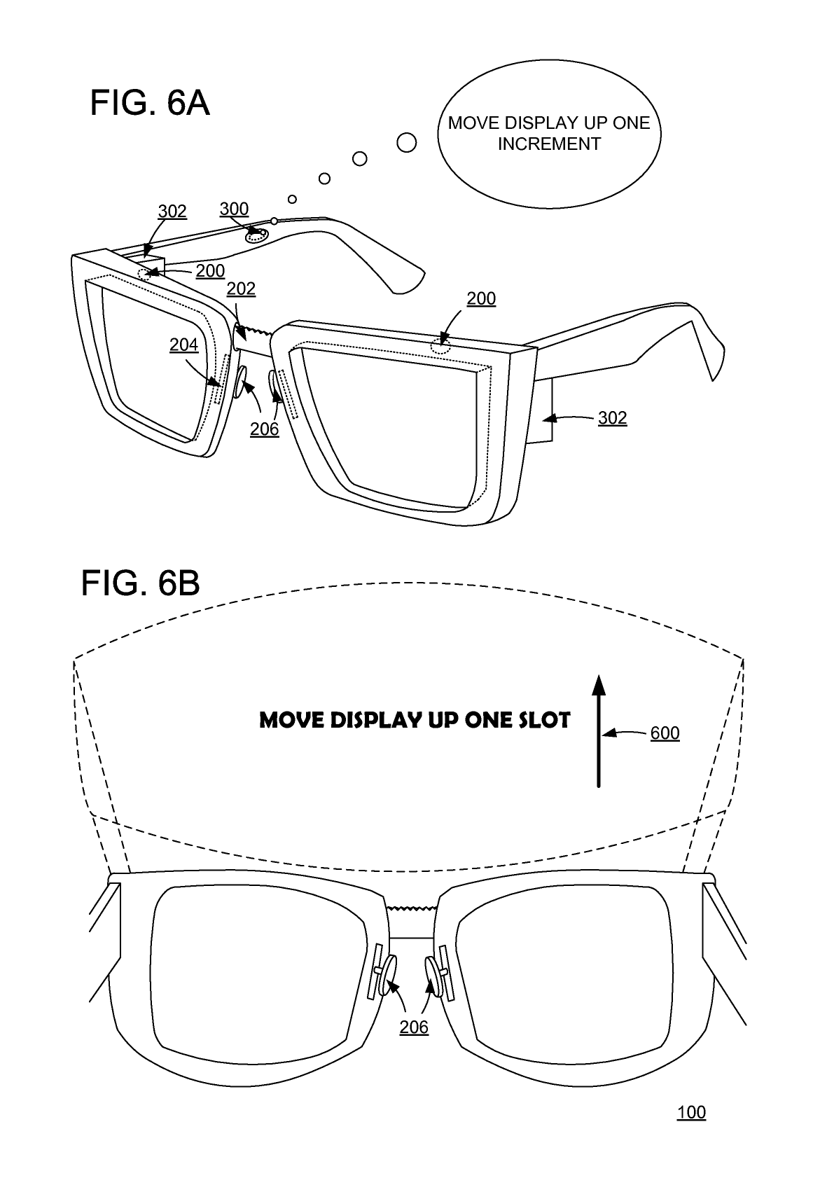

FIGS. 5A-5B illustrate an example embodiment of a near-eye display 500 in which a reverse display optical path is used to deliver an image of a user's eye to a camera. In the depicted embodiment, the camera is a part of an eye-tracking system, and the display optical path is used to deliver light from an eye tracking light source to the user's eye, as well as to deliver images of the user's eye to the camera and to display images to the user. The near-eye display 500 includes a display subsystem, shown schematically at 502, configured to produce an image for display to user 504. The display subsystem 502 may comprise any suitable components for producing images for display, including but not limited to a microdisplay and one or more light sources. Light from display subsystem 502 travels along the display optical path (indicated by rays originating at the display subsystem 502) to reach the user's eye 506. It will be understood that separate near-eye displays 500 may be used for left eye and right eye displays.

The near-eye display 500 also includes an eye tracking system comprising an eye tracking camera 512 and one or more light sources 508 (e.g. infrared light sources) configured to produce light for reflection from the user's eye. As shown in FIG. 5B, an image of the user's eye may be acquired using eye tracking camera 512 via light that travels from the user's eye along a reverse display optical path (e.g. along at least a portion of the display optical path in a reverse direction) to the eye tracking camera 512. In the depicted example, rays originating from the user's eye are diverted off of the display optical path by a beam splitter (e.g. a polarizing beam splitter) 514 located immediately before the camera along the reverse display optical path. However, the optical path to the camera may take any other suitable form. The eye tracking system may detect a location of the eye and/or anatomical structures thereof (e.g. the user's pupil) and also of reflections from light sources 508 in the image data acquired via eye tracking camera 512, and from this information determine a direction in which the eye is gazing. It will be understood that the ray traces shown in FIGS. 5A-5B are intended to be illustrative and not limiting in any manner.

As the eye tracking camera 512 is configured to capture an image of the user's eye, the eye tracking camera 512 also may be used to acquire images of a user's eye during a fitting process for a head-mounted display. As mentioned above, when initially fitting a head-mounted display, a user may perform sufficient fit adjustments to find a coarse fit that provides an acceptable level of performance. Once the user performs these adjustments, at least a portion of the user's pupil will be in the view of the eye tracking system. Image data from the eye tracking camera may then be used to determine a location of the user's eye, and to determine an adjustment to make or recommend.

Returning to FIG. 4, method 400 includes, at 404, detecting a location of the eye in the image. Any suitable method may be used to locate the user's eye and/or anatomical features thereof in the image data, including but not limited to pattern matching techniques. The detected location of the user's eye then may be used to determine a relative position between the user's eye and the target viewing position for the near-eye display. As such, method 400 includes, at 406, determining a relative position of the user's eye to a target viewing position of the near-eye display. This may comprise determining locations of a first eye and of a second eye to a first eye target viewing position and a second eye target viewing position in some embodiments.

The relative position determined may depend upon a horizontal and/or vertical offset of the eye from the target viewing position in the image, and also upon a distance of the eye from the near-eye display device. Any suitable method may be used to determine the distance of the eye from the near-eye display device. For example, in some embodiments, a predetermined distance (e.g. based upon a design of the system compared to an average anatomy of expected users) may be used based upon the design of a near-eye display device.

Method 400 further includes, at 408, determining an adjustment to make to the head-mounted display to align the location of the eye with the target viewing position. Method 400 additionally includes, at 410, outputting the recommendation and/or making the adjustment automatically. The recommendation may be determined in any suitable manner For example, as mentioned above, the recommendation may be made based upon a detected offset of the user's eye (or each of the user's eyes) from the target viewing position (or each of two target viewing positions) in combination with information regarding the effect of an adjustment mechanism. As a non-limiting example, if it is determined to increase a separation of a left eye display and right eye display by three millimeters and the increment of adjustment is one half millimeter, then it may be determined to recommend to the user to increase a horizontal adjustment value by six increments of adjustment. It will be understood that, where multiple adjustments are to be made, the multiple adjustments may be made via any suitable combination of automatic and manual adjustments, depending upon the adjustment mechanisms provided.

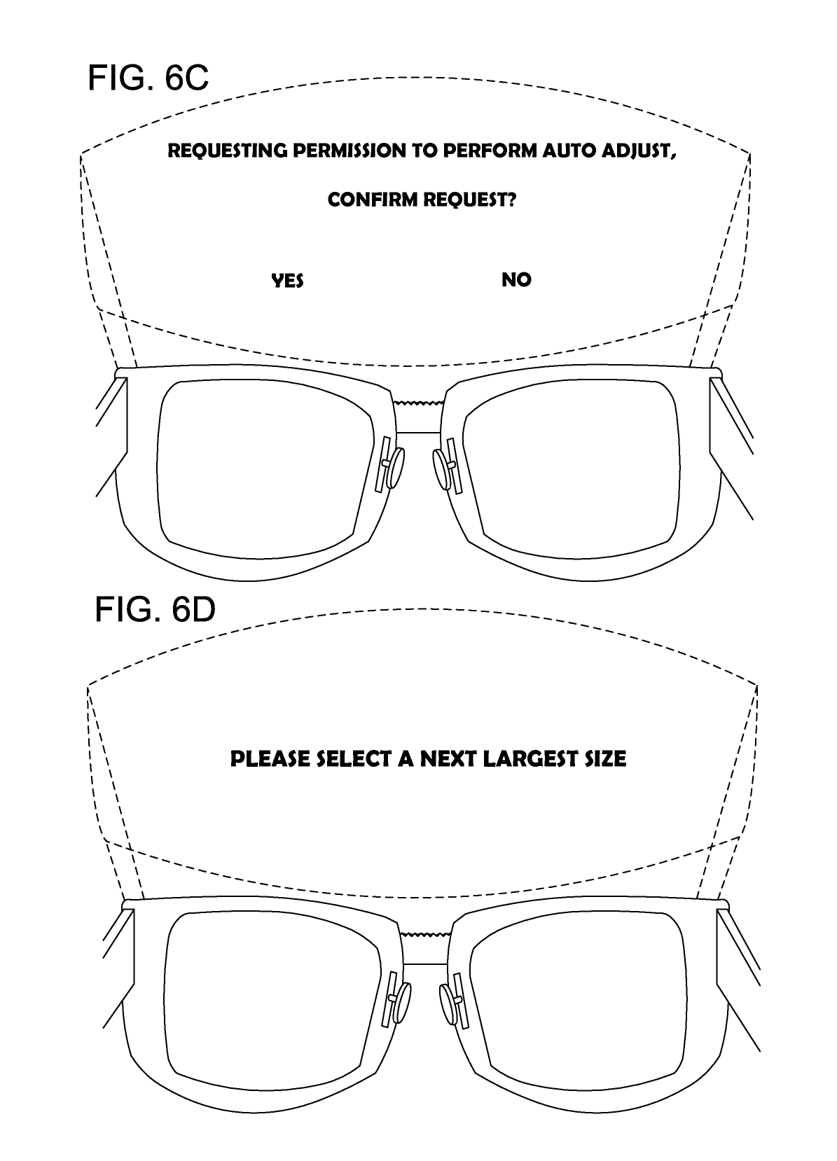

As mentioned above, a recommendation of adjustments to make may take any suitable form. FIGS. 6A-6D illustrate example embodiments of recommendations that may be output by the near-eye display device. It will be understood that these examples are depicted for illustrative purposes, and that a recommendation may be output in any other suitable form. First, FIG. 6A shows an example of an acoustic recommendation output via speakers 300. In the depicted example, the recommendation comprises a recommended manual adjustment to move the displays (e.g. left eye and right eye displays) up one increment. In some embodiments, a recommendation may be output in both visual and acoustic form. Thus, FIG. 6B shows the adjustment recommendation of FIG. 6A of “move display up one increment” as displayed to a user. It will be understood that any other suitable adjustment may be recommended, including but not limited to horizontal and/or angular adjustments.

Recommended adjustments also may be output via images, such as icons, symbols, etc., that direct user how to perform the adjustment. For example, as shown in FIG. 6B, the adjustment recommendation of “move display up one increment” is reinforced using arrow 600. Further, arrow 600 or another suitable image may be presented without text. Other examples include animations and/or videos of the recommended adjustments being performed, step by step instructions, and/or other any other suitable information.

In some embodiments, a near-eye display may include motors or other suitable electronic mechanisms for allowing determined adjustments to be performed automatically. In such embodiments, a user may be prompted for confirmation to perform the adjustment, or the adjustment may be automatically performed without user confirmation. FIG. 6C shows an example of an output comprising displayed text requesting confirmation to perform an automatic adjustment. It will be understood that a user input confirming or declining the adjustment may be made in any suitable manner via any suitable input device.

Further, as mentioned above, in some embodiments a near-eye display device may be available in a range of sizes configured to fit different users of having different anatomies (e.g. head sizes, interpupillary distances, etc.). Such near-eye displays may be configured to determine if a user is wearing an appropriately sized near-eye display, and if the user is not wearing an appropriately sized near-eye display, to output a recommendation that direct the user to use to a different size near-eye display. As an example, FIG. 6D shows the near-eye display outputting a recommendation to select a next largest size device. It will be understood that each size device may have adjustment mechanisms that allow a user to fine tune the fit using recommendations as described above.

To allow a determination to be made to recommend a different sized device, the near-eye display device may include a measuring system, such as an encoder, for each adjustment mechanism. The measuring system may detect a current absolute setting of the adjustment mechanism, and from the current setting determine if an adjustment can be made based upon the remaining adjustment range available. The recommendation to select a different size then may be made if insufficient adjustment range is available. The use of such an encoder (or other measuring mechanism) may provide for other capabilities as well. For example, the absolute adjustment setting mechanism may allow for the absolute measurement of eye dimensional information, which may be used for user identification and/or other device features,

The use of cameras to determine a location of a user's eyes relative to a target viewing position may offer other advantages. For example, the interpupillary distance of a user decreases as a user views objects at closer and closer distances. Thus, in a near-eye display device configured to display stereoscopic images, the interpupillary distance may be determined via image data from the cameras along with information regarding how far apart the cameras are. The rendering of stereoscopic images then may be adjusted based upon changes in the interpupillary distance. This may help to accurately render stereoscopic images at close apparent distances.

In some embodiments, the methods and processes described herein may be tied to a computing system of one or more computing devices. In particular, such methods and processes may be implemented as a computer-application program or service, an application-programming interface (API), a library, and/or other computer-program product.

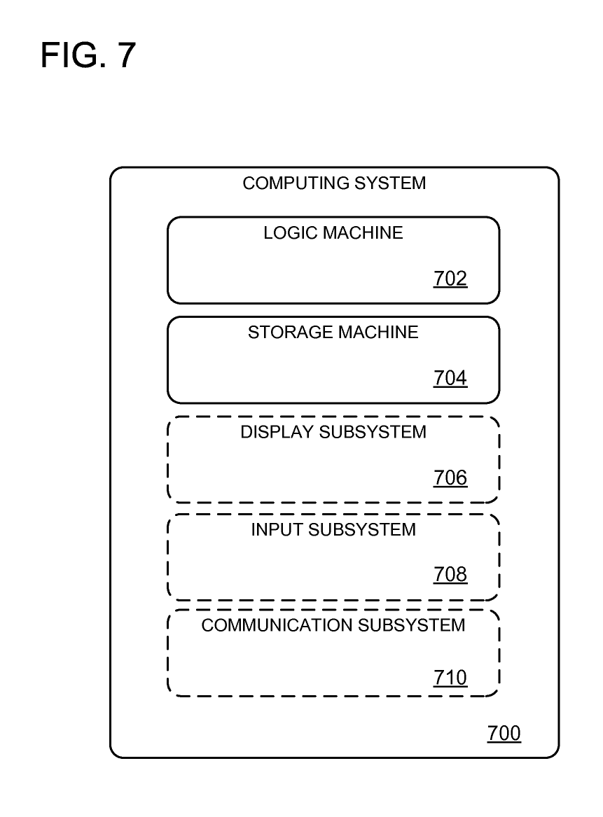

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phones), wearable computing devices such as head-mounted display devices, other near-eye display devices, and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices comprising computer-readable storage media. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices and excludes a propagating signal per se. However, aspects of the instructions described herein alternatively may be propagated by a communication medium (e.g., an electromagnetic signal, an optical signal, etc.), as opposed to being stored by a computer readable storage medium.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” and the like may be used to describe an aspect of computing system 700 implemented to perform a particular function. In some cases, a program may be instantiated via logic machine 702 executing instructions held by storage machine 704. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

Display subsystem 706 may be used to present a visual representation of data held by storage machine 704. This visual representation may take the form of a graphical user interface (GUI) displayed, for example, on a near-eye display device. As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. For example, a near-eye display device may deliver an image to a user via one or more waveguides, via projection optics, and/or in any other suitable manner. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are presented for example, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a near-eye display device comprising a display and a display optical path that delivers images from the display to an eye of a user, a method of aligning a near-eye display with the eye of a user, the method comprising:
receiving from a camera an image of the eye along a reverse display optical path;
detecting a location of the eye in the image;
determining a relative position of the eye with regard to a target viewing position of the near-eye display; and
determining an adjustment to make to align the location of the eye with the target viewing position.

2. The method of claim 1, further comprising automatically performing the adjustment determined

3. The method of claim 1, further comprising outputting a recommendation to make the adjustment.

4. The method of claim 3, wherein outputting the recommendation comprises outputting one or more of an acoustic recommendation and a visual recommendation.

5. The method of claim 4, wherein outputting the visual recommendation comprises displaying an arrow that indicates a direction in which to adjust the near-eye display.

6. The method of claim 3, wherein the recommendation comprises one or more of a recommended vertical adjustment and a recommended horizontal adjustment.

7. The method of claim 3, wherein the recommendation directs a user to use to a different size near-eye display if an available range of adjustment is insufficient to make the adjustment.

8. The method of claim 3, wherein the outputting the recommendation comprises providing one or more of a haptic output and a tactile output.

9. The method of claim 1, wherein the adjustment is determined based upon a determined interpupillary distance of a user.

10. The method of claim 1, wherein the camera comprises an eye tracking system camera.

11. The method of claim 10, wherein the display optical path comprises a beam splitter, and wherein the beam splitter is configured to direct the image of the eye toward the camera.

12. On a computing device comprising a near-eye display for each eye of a user, a method of aligning the near-eye display to a first eye and a second eye of a user, the method comprising:
receiving from a first camera an image of the first eye via a reverse display optical path for a display for the first eye;
receiving from a second camera an image of the second eye via a reverse display optical path for a display of the second eye;
detecting a location of the first eye in the image of the first eye and a location of the second eye in the image of the second eye;
determining a relative position of the first eye to a first eye target viewing position of the near-eye display;
determining a relative position of the second eye to a second eye target viewing position; and
determining an adjustment to make to the near-eye display based upon one or more of the relative position of the first eye to the first eye target viewing position and the relative position of the second eye to the second eye target viewing position.

13. The method of claim 12, further comprising outputting a recommendation of the adjustment to make.

14. The method of claim 12, wherein the adjustment is determined based upon an interpupillary distance.

15. The method of claim 12, further comprising performing the adjustment automatically.

16. The method of claim 12, further comprising determining an absolute position of an adjustment mechanism, and outputting a recommendation to use a different sized device if an available range of adjustment is insufficient to make the adjustment.

17. On a computing device, a method of operating a near-eye display device, the method comprising:
receiving from a first camera an image of a first eye, the first camera configured to receive the image of the first eye via a reverse display optical path;
receiving from a second camera an image of a second eye, the second camera configured to receive the image of the second eye via a reverse display optical path;
detecting a location of the first eye in the image of the first eye and a location of the second eye in the image of the second eye;
determining an interpupillary distance of a user from the location of the first eye and the location of the second eye; and
outputting a recommendation of an adjustment to make to the near-eye display device to align the near-eye display device with the first eye and the second eye of the user.

18. The method of claim 17, wherein outputting the recommendation comprises outputting information regarding a recommended manual adjustment.

19. The method of claim 17, wherein the first camera and the second camera each are a part of an eye tracking system.

20. The method of claim 17, wherein the recommendation directs a user to use to a different size near-eye display device.
